(19) United States
(12) Patent Application Publication
(10) Pub. No.: US 2016/0148540 A1
(43) Pub. Date: May 26, 2016

(54) Device and Method for a Medical Simulator With Anatomically Accurate Inflatable Features

(71) Applicant: SIMnext, LLC, Peoria, IL (US)

(72) Inventors: John Vozenilek, Peoria, IL (US); Eliot Bethke, Champaign, IL (US); Justin Drawz, Chicago, IL (US); Kevin Urbain, Peoria, IL (US)

(21) Appl. No.: 14/950,537

(22) Filed: Nov. 24, 2015

Related U.S. Application Data
(60) Provisional application No. 62/084,863, filed on Nov. 26, 2014.

(51) Int. Cl. G09B 23/30

(52) U.S. Cl. CPC G09B 23/30

(57) ABSTRACT

A device is provided for anatomical simulations. The device includes: an anatomical unit; an inflatable anatomical feature embedded within the anatomical unit, the inflatable anatomical feature being capable of anatomical simulations based at least in part on geometry and placement of the inflatable anatomical feature; a pressure generator capable of generating pressure to actuate the inflatable anatomical feature; a feedback sensor capable of providing a feedback based at least in part on the actuation of the inflatable anatomical feature; and a controller unit capable of affecting the pressure generator to adjust the pressure based at least in part on the feedback.

### PRIORITY CLAIMS

This application claims priority and benefit to U.S. Provisional Application Ser. No. 62/084,863, filed 26 Nov. 2014, of which the entire disclosure is incorporated by reference herein for all purposes.

### STATEMENT REGARDING FEDERALLY SPONSORED RESEARCH OR DEVELOPMENT

This application is not the subject of any federally sponsored research or development.

### THE NAMES OF THE PARTIES TO A JOINT RESEARCH AGREEMENT

There has been no joint research agreements entered into with any third parties.

### BACKGROUND OF THE INVENTION

1. Field of the Invention

The embodiments of the present invention relate generally to a device and method for medical simulations. In particular, the embodiments of the present invention are directed to a medical simulator with anatomically accurate inflatable features.

2. Description of the Related Art

In the human body, a multitude of conditions may arise which present themselves with anatomical abnormalities. As such, in the general practice of medicine there are often clinical findings that display a range of severity. For example, atherosclerotic plaques in the carotid artery can present with varying degrees of severity, often characterized by the acceleration of the blood flow profile local to the constriction caused by the plaque. This type of narrowing of a vessel is referred to clinically as a stenosis.

In teaching the use of Doppler ultrasound to identify and diagnose stenosis conditions which present with varying degrees of severity, there is a need for an anatomical trainer that can be adjusted automatically to recreate the range of disease states and presentations that may occur in the human body. There is an additional need in the field of medical education to reproduce, to those unfamiliar with relevant pathology, rare and diagnostically relevant cases in such a manner that reinforces diagnostic skills.

### SUMMARY OF THE INVENTION

Devices and methods are provided for anatomical simulations. An example device includes: an anatomical unit; an inflatable anatomical feature embedded within the anatomical unit, the inflatable anatomical feature being capable of anatomical simulations based at least in part on geometry and placement of the inflatable anatomical feature; a pressure generator capable of generating pressure to actuate the inflatable anatomical feature; a feedback sensor capable of providing a feedback based at least in part on the actuation of the inflatable anatomical feature; and a controller unit capable of affecting the pressure generator to adjust the pressure based at least in part on the feedback.

As an example, a method is provided for anatomical simulations. Pressure is generated to actuate an inflatable anatomical feature embedded within an anatomical unit for anatomical simulations based at least in part on geometry and placement of the inflatable anatomical feature. Feedback is provided based at least in part on the actuation of the inflatable anatomical feature to the controller unit. The pressure is adjusted based at least in part on the feedback.

As another example, a device is provided for anatomical simulations. The device includes: an inflatable anatomical feature embedded within an anatomical unit, the inflatable anatomical feature being capable of anatomical simulations based at least in part on geometry and placement of the inflatable anatomical feature. The inflatable anatomical feature includes one or more inflatable pockets made of elastic materials. Portions of the one or more inflatable pockets are encased with a textile. The portions of the one or more inflatable pockets encased with the textile expand along a contour of the textile in response to the pressure. The device further includes: a pressure generator capable of generating pressure to actuate the inflatable anatomical feature; and a controller unit capable of affecting the pressure generator to adjust the pressure based at least in part on the actuation of the inflatable anatomical feature.

As yet another example, a device is provided for anatomical simulations. The device includes: an anatomical unit; an inflatable anatomical feature embedded within the anatomical unit, the inflatable anatomical feature being capable of anatomical simulations based at least in part on geometry and placement of the inflatable anatomical feature; a pressure generator capable of providing a fluid flow for generating pressure; a manifold capable of selectively diverting the fluid flow from the pressure generator to actuate the inflatable anatomical feature; a feedback sensor capable of generating a feedback based at least in part on the pressure; a programmable microcontroller capable of generating a signal based at least in part on the feedback; and an electronic control element capable of affecting the pressure generator to adjust the pressure based at least in part on the signal from the programmable microcontroller.

### BRIEF DESCRIPTION OF THE DRAWINGS

Features of the embodiments of the present invention are disclosed in the accompanying drawings, wherein similar reference characters denote similar elements throughout the several views, and wherein:

FIG. 1 depicts an example diagram showing a dynamic medical simulator;

FIG. 2 depicts an example diagram showing a controller unit of the dynamic medical simulator as shown in FIG. 1;

FIG. 3 depicts another example diagram showing the controller unit of the dynamic medical simulator as shown in FIG. 1;

FIG. 4 and FIG. 5 depict example diagrams showing an inflatable anatomical feature in an anatomical unit;

FIG. 6 depicts an example diagram showing an inflatable anatomical feature;

FIG. 7 and FIG. 8 depict example diagrams showing different views of an inflatable anatomical feature;

FIG. 9 and FIG. 10 depict example diagrams for simulating a stenosis;

FIG. 11 depicts an example diagram showing certain components of a controller unit; and

FIG. 12 depicts an example flow chart for anatomical simulations.

### DETAILED DESCRIPTION

The embodiments of the present invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete and will convey the scope of the invention to those skilled in the art.

In the following description, like reference characters designate like or corresponding parts throughout the figures. Additionally, in the following description, it is understood that terms such as “in,” “on,” “side,” “from,” “inside,” and the like, are words of convenience and are not to be construed as limiting terms.

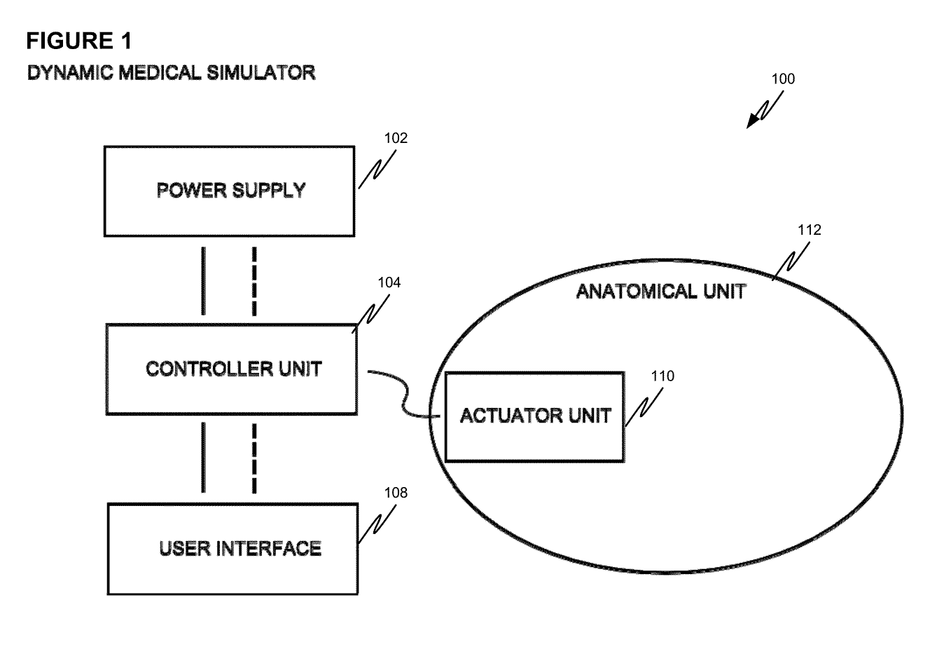

FIG. 1 depicts an example diagram showing a dynamic medical simulator. As shown in FIG. 1, the simulator 100 can change the presentation of anatomical features dynamically within a medical, anatomical trainer to allow for varying diseases to be presented or hidden as well as portray varying degrees of severity of diseases. The ability of the simulator 100 to dynamically change the presence and severity of disease states would be invaluable to educators as a training tool and as an evaluation tool. In this context, disease refers to any anatomical abnormality whose clinical presentation represents a valid diagnostic finding either by the mere presence of the abnormality or by a gradation of the state of the abnormality.

The simulator 100 includes an anatomical unit 112 which contains an actuator unit 110 for anatomical simulations, e.g., simulating anatomical abnormalities. In some embodiments, the actuator unit 110 includes an anatomically accurate inflatable feature which simulates anatomical abnormalities by the geometry and placement of the inflatable feature. For example, the anatomically accurate inflatable feature includes one or more inflatable pockets.

The simulator 100 allows physical manipulation of inflatable anatomical features in a controllable and reversible manner. For example, the simulator 100 produces physical manipulation of inflatable anatomical features within the anatomical unit 112 in a controllable and reversible manner by utilizing fluid pressure and volumetric displacement where the inflatable anatomical features are designed to replicate the appearance and effects of various abnormalities in a human body. As an example, fluid used to actuate the anatomically accurate inflatable feature includes any medium capable of continually deforming (flowing) under applied shear stresses.

The simulator 100 can recreate the anatomical features dynamically and automatically within the anatomical unit 112 and would be a valuable tool for any physician needing experience locating and or diagnosis various clinical conditions. In some embodiments, the simulator 100 can simulate different anatomical abnormalities by placing the one or more pockets in various places within the anatomical unit 112. Examples of the different anatomical abnormalities include tumors, cysts, edemas or other masses or fluid buildup, inflation of an organ, infection, torsion, fistulas, stenoses, etc.

The simulator 100 can recreate varying degrees of physical manipulations within the anatomical unit 112. In certain embodiments, the simulator 100 can controllably recreate varying degrees of physical manipulations within an anatomical medical trainer by controlling the degree of inflation of the anatomically accurate inflatable feature using a control feedback loop (e.g., involving a controller unit 104 and the anatomical unit 112) to ensure proper setting. For example, the anatomical unit 112 includes a sealed housing designed to replicate anatomical conditions in a human body.

In an embodiment, a user would be able to control the physical manipulation of the inflatable anatomical features (e.g., the one or more inflatable pockets) through a user interface 108. For example, the user may provide inputs related to the desired physical manipulation, and a software application associated with the user interface 108 sends certain command signals to the controller unit 104 that is capable of receiving the command signals and calculating a pressure and/or displacement required to achieve the requested physical manipulation in the inflatable anatomical features.

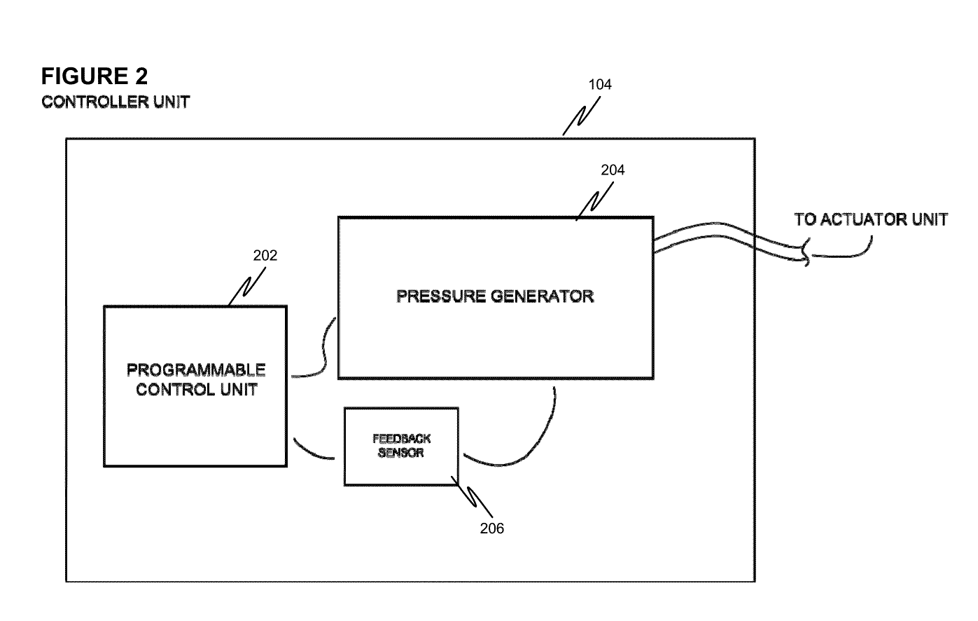

FIG. 2 depicts an example diagram showing the controller unit 104 of the dynamic medical simulator 100. As shown in FIG. 2, a pressure generator 204 within the controller unit 104 generates pressure to actuate the actuator unit 110. In some embodiments, a feedback sensor 206 provides a feedback to a programmable control unit 202 that is capable of controlling the pressure generator 204 to adjust the pressure for actuating the actuator unit 110. For example, the feedback sensor 206 may include, but are not limited to, pressure sensors, potentiometers, flow sensors, or electro-optical sensors. In one embodiment, the feedback sensor 206 provides feedback to the programmable control unit 202 which uses the feedback to determine the pressure and/or displacement of the actuator unit 110 achieved during control of the pressure generator 204.

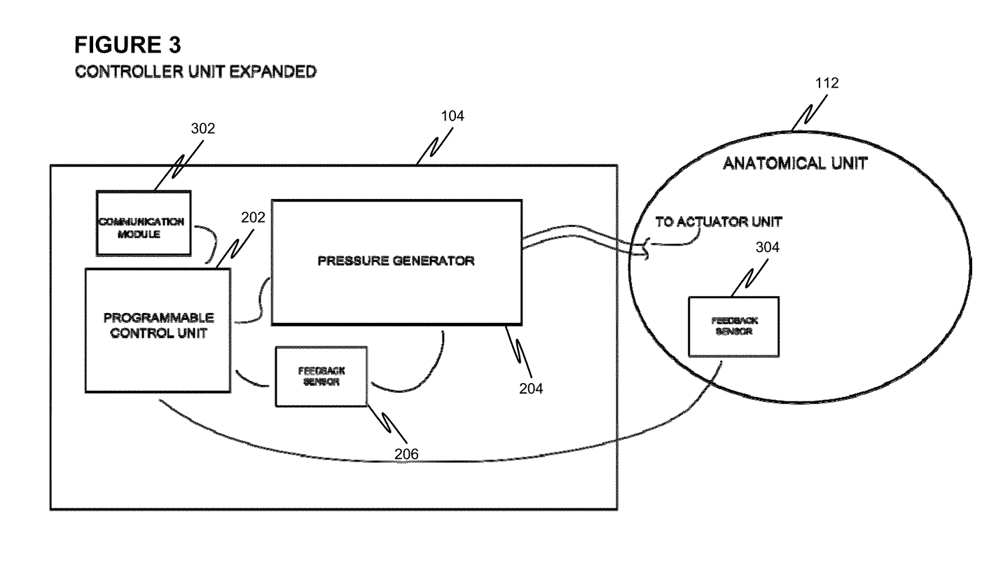

FIG. 3 depicts another example diagram showing the controller unit 104 of the dynamic medical simulator 100. As shown in FIG. 3, a feedback sensor 304 within the anatomical unit 112 detects the actuation of the actuator unit 110 and provides a feedback to the programmable control unit 202 which uses the feedback from the feedback sensor 304 (and/or the feedback sensor 206) to determine the pressure and/or displacement of the actuator unit 110 achieved during control of the pressure generator 204. For example, the feedback sensor 304 may include, but are not limited to, pressure sensors, potentiometers, flow sensors, or electro-optical sensors.

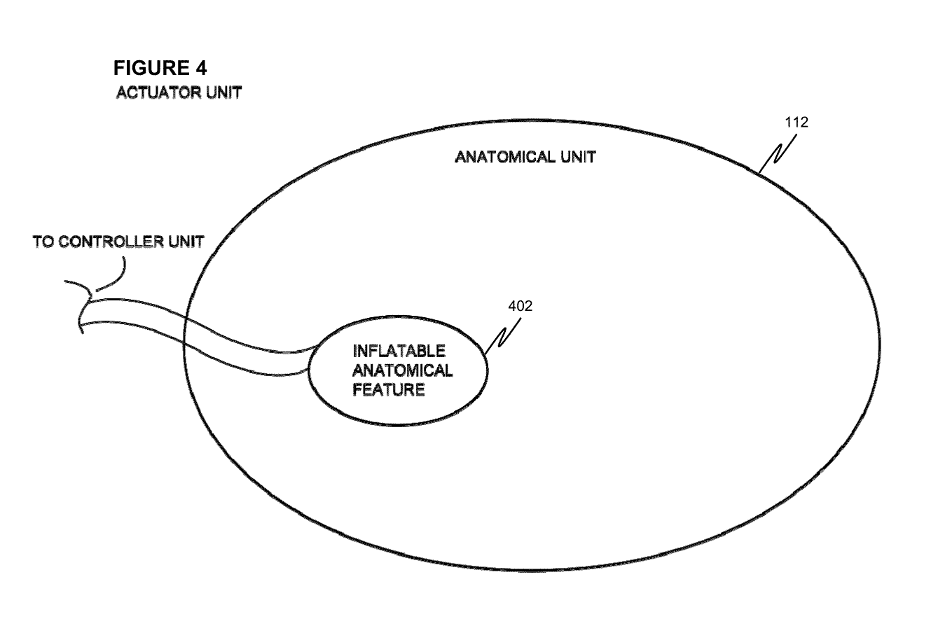

FIG. 4 depicts an example diagram showing an inflatable anatomical feature in the anatomical unit 112. As shown in FIG. 4, the pressure actuated mechanism 402 is connected to the controller unit 104. Specifically, the pressure generator 204 within the controller unit 104 generates pressure to actuate the inflatable anatomical feature 402. In some embodiments, the inflatable anatomical feature 402 is included in the actuator unit 110.

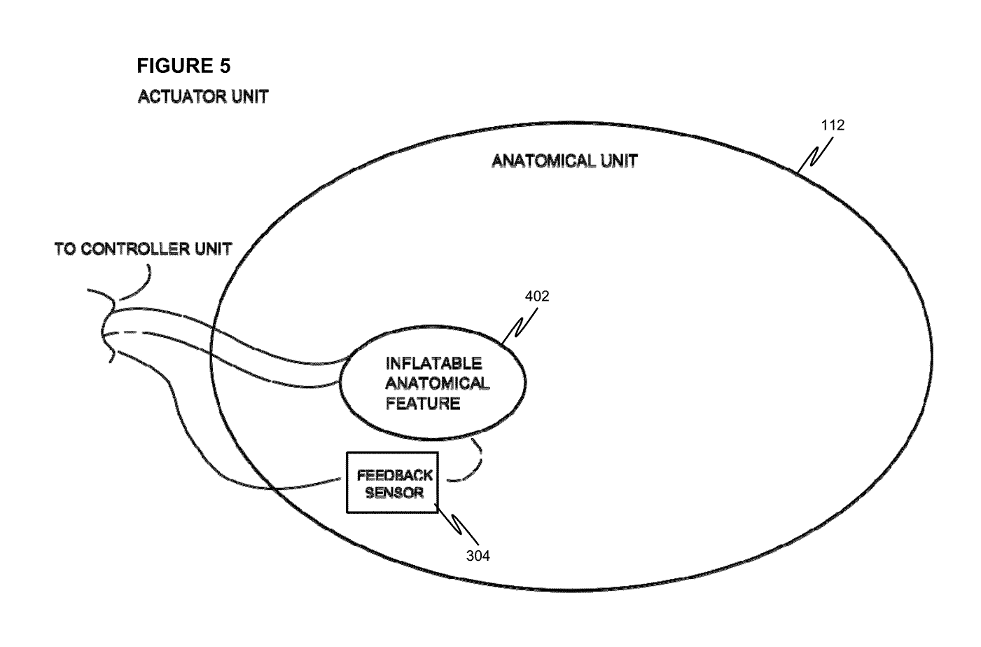

In certain embodiments, the feedback sensor 304 is placed near the inflatable anatomical feature 402 to detect the pressure and/or displacement of the inflatable anatomical feature 402 and provides a feedback to the controller unit 104, as shown in FIG. 5. For example, the inflatable anatomical feature 402 corresponds to an anatomically accurate inflatable feature.

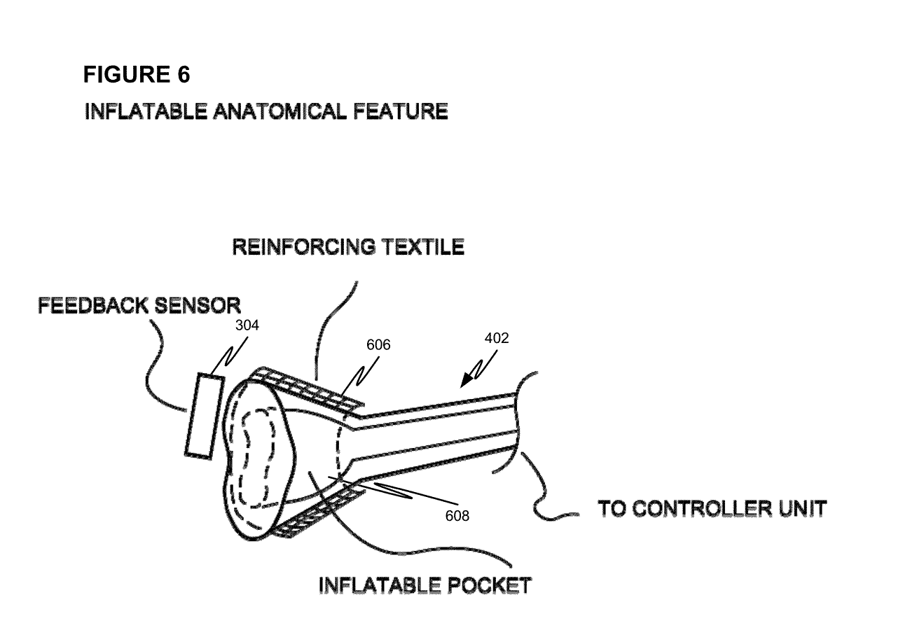

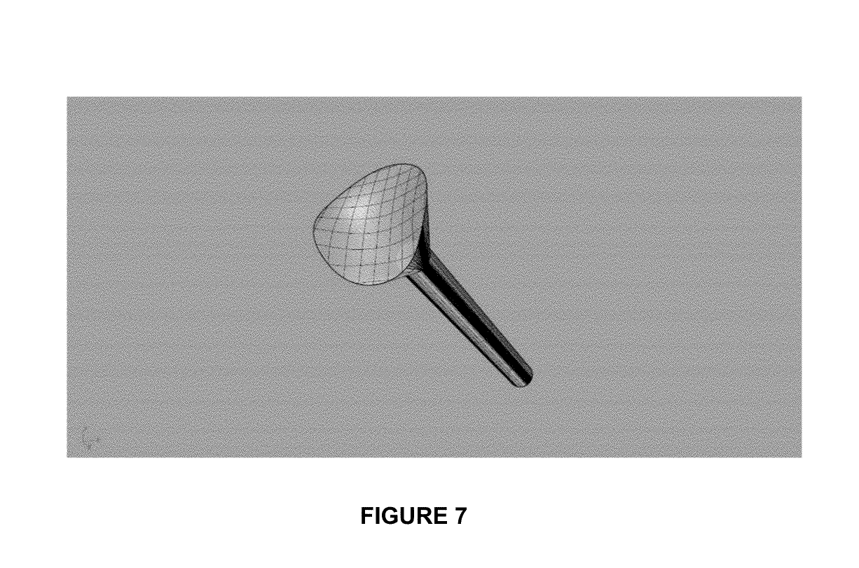

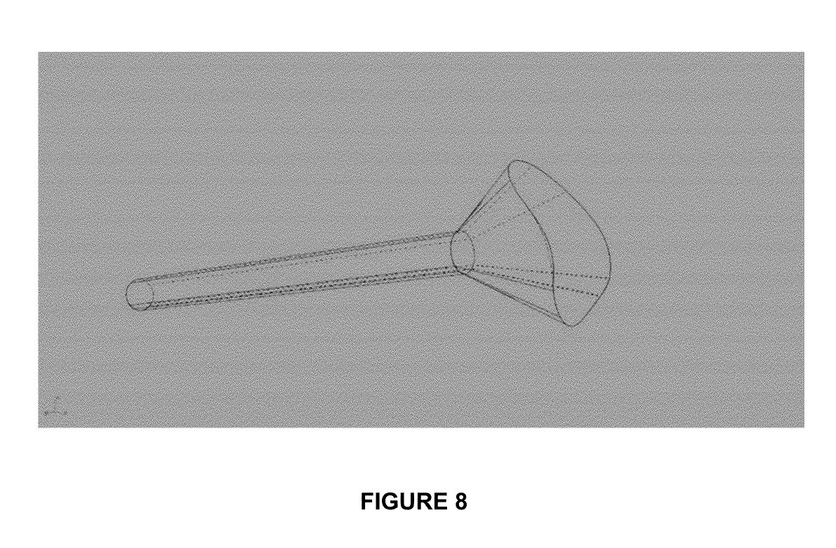

FIG. 6 depicts an example diagram showing the inflatable anatomical feature 402. As shown in FIG. 6, the inflatable anatomical feature 402 includes a pressure actuator 608 (e.g., an inflatable pocket). FIG. 7 and FIG. 8 depict example diagrams showing different views of the inflatable anatomical feature 402.

The inflatable pocket of the pressure actuator 608 is reinforced with a textile 606 in specific places around the inflatable pocket to achieve more controlled behavior when pressurized. To those skilled in the art, textiles are known to be used for reinforcement in such applications as concrete and fiberglass and are well known for their ability to withstand high tension and act as a rigid structure under tension, but behave more fluid like under compression. In an embodiment, the textile 606 is used to alter the geometry of the inflatable pocket as it is inflated in order to produce more realistic presentations of human anatomical features. For example, if portions of the inflatable pocket are encased with the textile 606 and other portions are not encased, the portions encased by the textile 606 resist expansion due to inflation along the contour of the textile 606 under tension.

One inflatable pocket is shown in FIG. 6 merely as an example, which should not unduly limit the scope of the invention. One of ordinary skill in the art would recognize many variations, alternatives, and modifications. For example, a plurality of inflatable pockets may be included in the inflatable anatomical feature 402, where each inflatable pocket or any combination of the inflatable pockets are designed to simulate one or more anatomical features. The description related to the inflatable pocket herein can be applied to one or more inflatable pockets.

In an embodiment, the geometry of the inflatable pocket of the pressure actuator 608 may be custom designed to replicate a specific anatomical location and a desired pathology. For example, an inflatable pocket capable of portraying a certain disease state can be created from images or drawings of the healthy anatomy and designed such that the inflatable pocket appears to be a part of the healthy anatomy in an initial state, but is capable of reflecting a disease state when inflated. In one embodiment, the inflatable pocket is constructed from elastic materials including silicone rubber and similar rubber materials in order to reflect different gradations of disease, or pathology, ranging from healthy or normal to unhealthy or diseased. In certain embodiments, the inflation of inflatable pocket can be designed to produce local or global changes within the anatomical unit 112 including, but not limited to, inflation of a specific geometry, constriction of an existing geometry, rotation of an existing geometry about an axis, or translation of a geometry along a linear or curvilinear path.

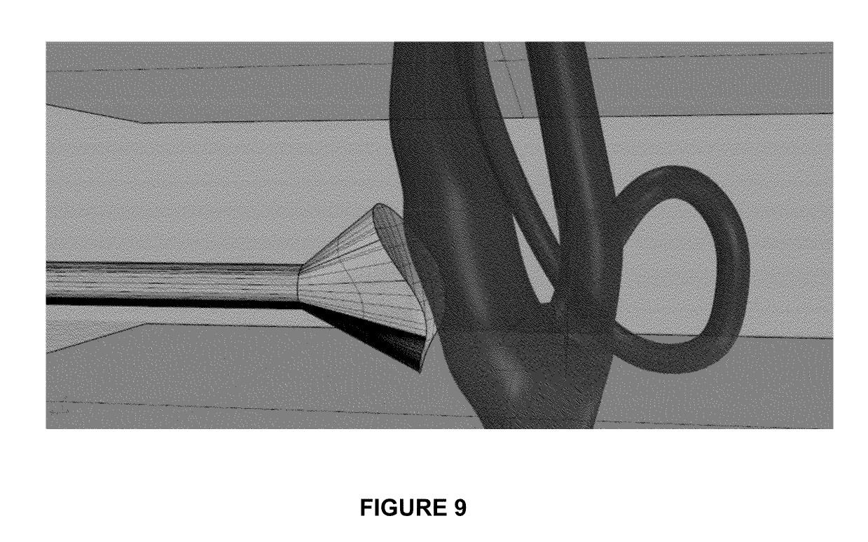

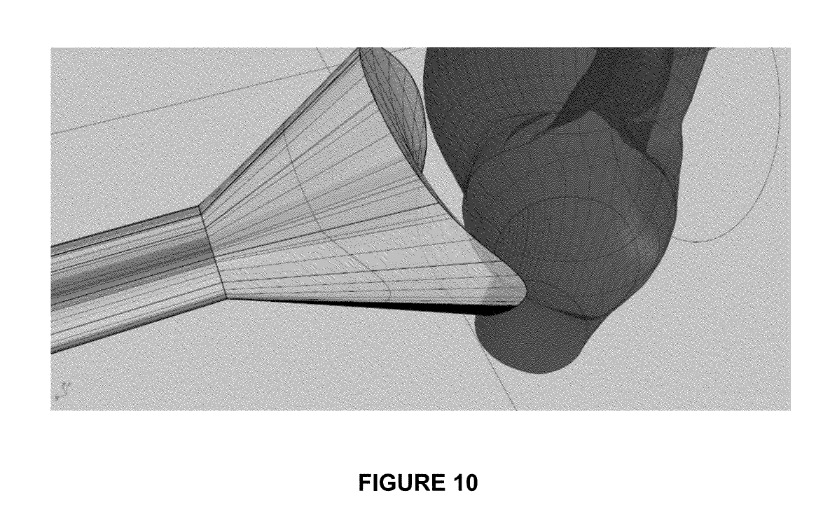

In some embodiments, the inflatable pocket may produce the local or global changes within the anatomical unit 112 where the geometries affected may take on the size and shape of specific anatomically accurate features including, but not limited to, tumors, cysts, fistulas, aneurisms, edemas, thrombi, plaques, abscesses, hematomas, or general inflammation. In one embodiment, the inflatable pocket geometry would be arranged inside the anatomical unit 112 so as to replicate real human anatomical behavior and appearance under ultrasound. For example, the inflatable pocket may be inflated to create a spherical geometry to simulate a tumor. As another example, the inflatable pocket may be inflated against a wall of a vessel so the inflatable pocket protrudes into the vessel lumen to simulate a stenosis, e.g., as shown in FIG. 9 and FIG. 10.

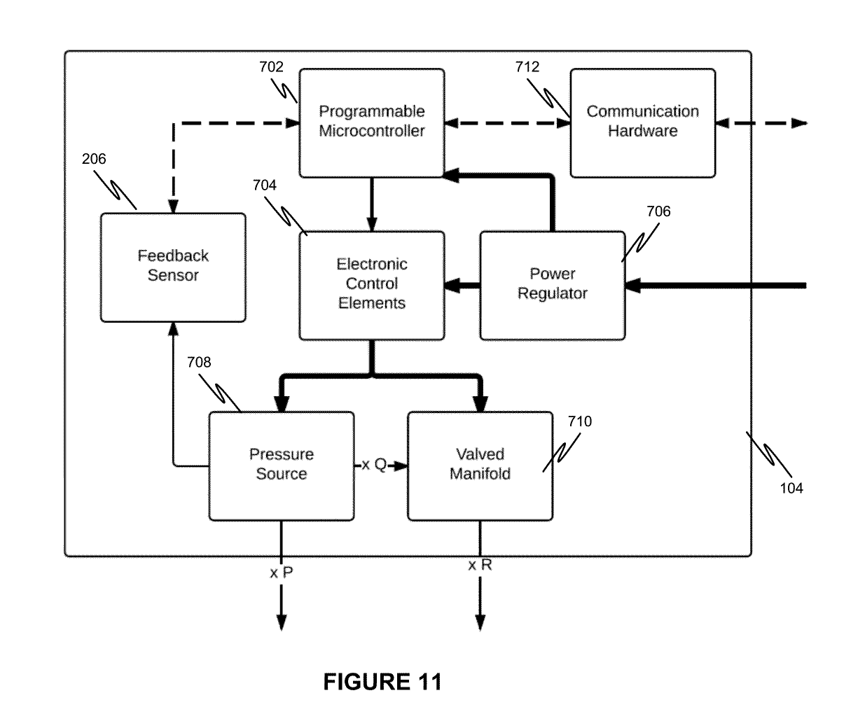

FIG. 11 depicts an example diagram showing certain components of the controller unit 104. As shown in FIG. 11, the controller unit 104 includes a programmable microcontroller 702 capable of sending and receiving signals, a power regulator 706 for providing power to electronic control components 704 and the programmable microcontroller 702, one or more pressure generators 708 (e.g., an electrically actuated syringe pump) for generating pressure, and a valved manifold 710 capable of selectively diverting fluid flow from the pressure generators 708 (e.g., the syringe pump).

For example, the inflatable anatomical feature 402 (e.g., including the inflatable pocket) is embedded within the sealed housing of the anatomical unit 112 and attached to the manifold 710 such that when inflated the inflatable anatomical feature 402 (e.g., including the inflatable pocket) changes size or shape to replicate realistic variations of real human anatomical features. Those skilled in the art will understand that the manifold 710 can be a network of fluid channels with a central channel out of which a plurality of secondary channels lead. In some embodiments, the controller unit 104 receives a signal to adjust the inflatable pocket of the inflatable anatomical feature 402 to a specific degree of inflation, selectively divert the output of the one or more pressure generators 708 (e.g., the syringe pump) by controlling one or more valves on the manifold 710, and control the pressure generators 708 (e.g., the syringe pump) to inflate or deflate the inflatable pocket accordingly.

In an embodiment, the fluid used to actuate the inflatable pocket of the inflatable anatomical feature 402 may have additives to enhance the appearance of the inflatable pocket under medical imaging including ultrasound, CT, MRI, X-ray, and others. Potential additives to the fluid include, but are not limited to, thickening agents, powders, oils, or other fine particulates designed to affect the transmission of electromagnetic or pressure waves through the inflatable pocket.

In specific embodiments, a plurality of pressure generators 708 may be implemented in the controller unit 104 where the pressure generators may output directly into an inflatable pocket or may output to a manifold. The pressure generators 708 may include, but are not limited to, electric peristaltic pumps, electric diaphragm pumps, electric piston pumps, electric gear pumps, electric rotary pumps, electric progressing cavity pumps, or electric syringe pumps. For example, the pressure generators 708 includes a syringe pump which comprises a linear DC electric motor with positional feedback that actuates a piston head in a fluid filled cylinder. In another example, the pressure generators 708 include two syringe pumps which are each connected to a unique central channel of the manifold 710 containing four solenoid valves, with each solenoid valve acting to control flow from the central channel of the manifold 710 to a secondary fluid line terminating in a unique inflatable pocket of the actuator unit 110. In certain embodiments, solenoid valves capable of being attached to the manifold 710 are direct acting solenoid valves and are each individually capable of controlling fluid flow from the central channel of the manifold 710 to a secondary fluid line branching off of the manifold 710, where each valve is at least capable of allowing or preventing flow from the central manifold channel into one secondary fluid channel. In some embodiments, each secondary fluid line branching off of the manifold 710 terminates in a unique inflatable pocket, forming a closed fluid system.

In an embodiment, a user would be able to control the degree of inflation of at least one inflatable pocket by using a software application associated with the user interface 108. For example, the software application has the ability to control the degree of inflation of at least one inflatable pocket embedded within the anatomical unit 112 by sending inflation command signals to the programmable microcontroller 702. The microcontroller 702 is capable of receiving the command signals, calculating a pressure and/or displacement required to achieve the requested inflation in the requested inflatable pocket, and then sending signals to a control unit that includes the electronic control elements 704. In an embodiment, these electronic control elements 704 may include power semiconductor devices or power ICs which may be digital or analog. The microcontroller 702 coordinates the control of the electronic control elements 710 which in turn may control the pressure generators 708, solenoid valves, and the feedback sensor 206 capable of providing feedback used to determine the degree of inflation of an inflatable pocket. In one embodiment, the sensor 206 provides feedback to the programmable microcontroller 702 which uses the sensor feedback to determine the pressure and/or displacement achieved during control of the pressure generators 708.

In certain embodiments, when a user requests an inflatable pocket be inflated to a specific degree by sending command signals via a software application, the programmable microcontroller 702 receives the signals and controls the electronic control elements 704 to provide power to the pressure generators 708 and one or more solenoid valves to achieve the requested degree of inflation in the requested pocket. Then the programmable microcontroller 702 sends a signal back to the software application to alert the user that the request has been completed successfully. In an embodiment of the invention, command signals may be communicated through certain wireless communication protocols and communication hardware 712. For example, the wireless communication protocols and communication hardware 712 includes, but not limited to, Bluetooth, WiFi, ZigBee, NFC, or a related radio frequency communication protocol. In another embodiment, communication may be achieved through a direct cable to a master control unit and communicate via SPI, I2C, USB, RS-232, Ethernet, or other serial protocols.

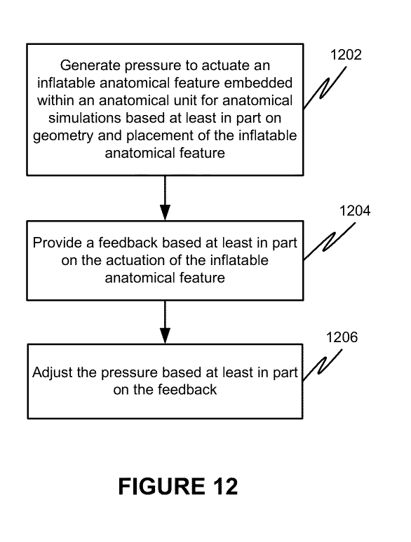

FIG. 12 depicts an example flow chart for anatomical simulations. At 1202, pressure is generated to actuate an inflatable anatomical feature embedded within an anatomical unit for anatomical simulations based at least in part on geometry and placement of an inflatable anatomical feature. At 1204, a feedback is provided based at least in part on the actuation of the inflatable anatomical feature. At 1206, the pressure is adjusted based at least in part on the feedback.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

We claim:

1. A device for anatomical simulations, the device comprising:
an anatomical unit;
an inflatable anatomical feature embedded within the anatomical unit, the inflatable anatomical feature being capable of anatomical simulations based at least in part on geometry and placement of the inflatable anatomical feature;
a pressure generator capable of generating pressure to actuate the inflatable anatomical feature;
a feedback sensor capable of providing a feedback based at least in part on the actuation of the inflatable anatomical feature; and
a controller unit capable of affecting the pressure generator to adjust the pressure based at least in part on the feedback.

2. The device according to claim 1, wherein the anatomical unit replicates one or more sections of a human body.

3. The device according to claim 1, wherein the inflatable anatomical feature includes an anatomically accurate inflatable feature.

4. The device according to claim 3, wherein the anatomically accurate inflatable feature includes one or more inflatable pockets made of elastic materials.

5. The device according to claim 4, wherein:
portions of the one or more inflatable pockets are encased with a textile; and
the portions of the one or more inflatable pockets encased with the textile expand along a contour of the textile in response to the pressure.

6. The device according to claim 1, wherein the inflatable anatomical feature is capable of being inflated or deflated in response to the pressure.

7. The device according to claim 6, wherein the pressure generator is capable of adjusting the pressure to change a degree of inflation or deflation of the inflatable anatomical feature.

8. The device according to claim 1, wherein the inflatable anatomical feature is capable of producing a change within the anatomical unit in response to the pressure.

9. The device according to claim 8, wherein the change within the anatomical unit includes one or more of the following: inflation of the geometry of the inflatable anatomical feature, constriction of the geometry of the inflatable anatomical feature, rotation of the geometry of the inflatable anatomical feature about an axis, and translation of the geometry of the inflatable anatomical feature along a linear or curvilinear path.

10. The device according to claim 8, wherein the inflatable anatomical feature is capable of changing the geometry of the inflatable anatomical feature to simulate a size and a shape of a specific anatomic feature.

11. The device according to claim 1, wherein the pressure generator includes: a pressure generator capable of providing a fluid flow to generate fluid pressure.

12. The device according to claim 11, wherein the pressure generator includes one of the following: an electric peristaltic pump, an electric diaphragm pump, an electric piston pump, an electric gear pump, an electric rotary pump, an electric progressing cavity pump, and an electric syringe pump.

13. The device according to claim 11, wherein the pressure generator further includes: a valved manifold capable of selectively diverting the fluid flow to adjust the pressure.

14. The device according to claim 13, wherein:
the pressure generator is capable of providing the fluid flow to the inflatable anatomical feature; and
the fluid flow includes additives to enhance appearance of the inflatable anatomical feature under medical imaging.

15. The device according to claim 13, wherein:
the manifold includes a central channel and one or more secondary fluid lines; and
one or more values are attached to the manifold, each valve being capable of controlling a fluid flow from the central channel to a secondary fluid line.

16. The device according to claim 15, wherein each secondary fluid line branches off the manifold and terminates in the inflatable anatomical feature.

17. The device according to claim 1, wherein the inflatable anatomical feature is custom designed to simulate a specific anatomical location and a desired pathology.

18. The device according to claim 1, wherein the controller unit includes a programmable microcontroller capable of determining the pressure and/or displacement of the inflatable anatomical feature based at least in part on the feedback.

19. A device for anatomical simulations, the device comprising:
an inflatable anatomical feature embedded within an anatomical unit, the inflatable anatomical feature being capable of anatomical simulations based at least in part on geometry and placement of the inflatable anatomical feature;
wherein:
the inflatable anatomical feature includes one or more inflatable pockets made of elastic materials;
portions of the one or more inflatable pockets are encased with a textile; and
the portions of the one or more inflatable pockets encased with the textile expand along a contour of the textile in response to the pressure;
a pressure generator capable of generating pressure to actuate the inflatable anatomical feature; and
a controller unit capable of affecting the pressure generator to adjust the pressure based at least in part on the actuation of the inflatable anatomical feature.

20. A device for anatomical simulations, the device comprising:
an anatomical unit;
an inflatable anatomical feature embedded within the anatomical unit, the inflatable anatomical feature being capable of anatomical simulations based at least in part on geometry and placement of the inflatable anatomical feature;
a pressure generator capable of providing a fluid flow for generating pressure;
a manifold capable of selectively diverting the fluid flow from the pressure generator to actuate the inflatable anatomical feature;
a feedback sensor capable of generating a feedback based at least in part on the pressure;
a programmable microcontroller capable of generating a signal based at least in part on the feedback; and
an electronic control element capable of affecting the pressure generator to adjust the pressure based at least in part on the signal from the programmable microcontroller.
